(19) United States
(12) Patent Application Publication
(10) Pub. No.: US 2022/0355792 A1
(43) Pub. Date: Nov. 10, 2022

(54) METHOD AND DEVICE FOR TRAJECTORY PLANNING FOR A VEHICLE

(71) Applicant: Dr. Ing. h.c. F. Porsche Aktiengesellschaft, Stuttgart (DE)

(72) Inventors: Jan Filip, Borsov nad Vltavou (CZ); Ondrej Holub, Prag (CZ); Arathi Pai, Korntal-Muenchingen (DE)

(21) Appl. No.: 17/740,724

(22) Filed: May 10, 2022

(30) Foreign Application Priority Data
May 10, 2021 (DE) 10 2021 112 119.1

(51) Int. Cl. B60W 30/09; B60W 10/04; B60W 10/20

(52) U.S. Cl. CPC B60W 30/09; B60W 10/04; B60W 10/20; B60W 2720/106; B60W 2540/10; B60W 2540/18

(57) ABSTRACT

A method for trajectory planning of a vehicle includes storing a desired driving path of the vehicle. The method then includes observing external interference factors (2) on the vehicle. The method proceeds by using the driving path and the interference factors (2) to calculate tracking errors (3) and secondary conditions (4). The method then includes optimizing a trajectory (5) in such a way that the tracking errors (3) are reduced within the secondary conditions (4). A corresponding device, a corresponding computer program, and a corresponding storage medium also are provided.

### CROSS REFERENCE TO RELATED APPLICATION

This application claims priority on German Patent Application No 10 2021 112 119.1 filed May 10, 2021, the entire disclosure of which is incorporated herein by reference.

### BACKGROUND

Field of the Invention. The invention relates to a method for trajectory planning for a vehicle. The invention further relates to a corresponding device, a corresponding computer program, and a corresponding storage medium.

Related Art. The determination of a normally collision-free permitted path is referred to as path planning in the field of robotics and automotive technology. The predominantly local motion planning also takes into account dynamic restrictions of the moving object and the temporal course of the movement. Both tasks are grouped together in technical terminology under the term trajectory planning.

A linearized single-track two-wheel model for motion planning is used in K. Kritayakirana. Autonomous Vehicle Control at the Limits of Handling. Doctoral Thesis, Stanford University, June 2012, and J. Filip. Trajectory Tracking for Autonomous Vehicles. Master's Thesis, Czech Technical University, Prague, June 2018.

A kinematic model for lateral motion control with lateral error conditions for systematic collision avoidance is described by B. Gutjahr, L. Gröll, and M. Willing. Lateral Vehicle Trajectory Optimization Using Constrained Linear Time-Varying MPC. IEEE.

U.S. Pat. No. 9,731,755 B1 proposes a mathematical model of vehicle dynamics that includes a state variable, a steering control variable, and a future road perturbation factor that defines the impending road curvature, cambers and slopes of the road. The method defines an optimum steering control signal, which includes a feedback section and a forward coupling section. The forward coupling section includes the road perturbation factor. The method determines a state variable and a control variable for the current road curvature, the lateral inclination, and the inclination for the stationary motion of the vehicle for constant speed, yaw rate, and transverse speed. The method then introduces a new state variable and control variable for a dynamic vehicle motion for variable speed, yaw rate, and transverse speed, which is a difference between the state and control variables for predicted future times and the stationary variables.

U.S. Pat. No. 9,645,577 uses a vehicle motion model to produce a finite set of possible trajectories that start from the current location of the vehicle, and a performance criterion to select the optimum trajectory from this set.

US 2019/0235516 first uses a spline-curve based path optimization, followed by a spline-curve based optimization of the speed trajectory. An avoidance trajectory is generated using another method in the event that the optimization fails.

### SUMMARY OF THE INVENTION

The invention provides a method for trajectory planning for a vehicle, a corresponding device, a corresponding computer program, and a corresponding machine-readable storage medium.

The invention aims to extend vehicle stabilization from a pure speed stabilization in the form of an electronic stabilization system or an anti-lock braking system into a comprehensive position stabilization along the desired driving path to improve the control of the vehicle movement in difficult driving situations, to prevent loss of control, and to achieve a level of performance similar to that of a professional driver. The method also aims to reduce the burden on the human driver, reduce driver fatigue and improve safety, repeatability, and utilization of the test track during vehicle tests. The disclosure focuses on kinematic motion planning and position stabilization techniques.

One advantage of the motion planning system of the invention is its suitability for autonomous endurance testing of vehicles on private test sites. Since various road conditions are taken into account in the course of the motion planning, the solution also proves to be particularly robust. The required safety is ensured by operating within the traction limits of the vehicle and maintaining a safe distance from other vehicles. Finally, the proposed motion planning system can be deployed in embedded systems and in modern control units.

The optimization of the trajectory could fail. However, in the event of such a failure, an avoidance path that partially satisfies secondary conditions calculated on the basis of the desired driving path and external interference factors can be determined. Thus, it possible to plan a compensating trajectory that allows the tracking of the desired path using local re-planning in situations such as lane changes, overtaking, or avoidance maneuvers.

Longitudinal acceleration and curvature on the optimized trajectory are fed as control commands to a control device and are converted by the control device into individual pedal and steering movements. In this way, a modular software component is created that enables motion planning in real time on board an autonomous vehicle.

A corresponding embodiment thus accomplishes the task of creating a sequence of control commands so as to minimize the deviation between the desired driving path—consisting essentially of a sequence of desired vehicle positions—and the driving path predicted on the basis of the current vehicle status, a vehicle motion model and the control commands, while at the same time satisfying secondary conditions such as maximum values for the tire grip and circumvention of known obstacles.

Embodiments of the invention are shown in the drawings and will be explained in more detail in the following.

### BRIEF DESCRIPTION OF THE DRAWINGS

FIG. 1 shows a first embodiment based on a step-by-step architecture.

FIG. 2 shows a second embodiment based on a monolithic architecture.

FIG. 3 illustrates the interdependence of the components used in the local planning program, with arrows indicating the direction of signal flow.

### DETAILED DESCRIPTION

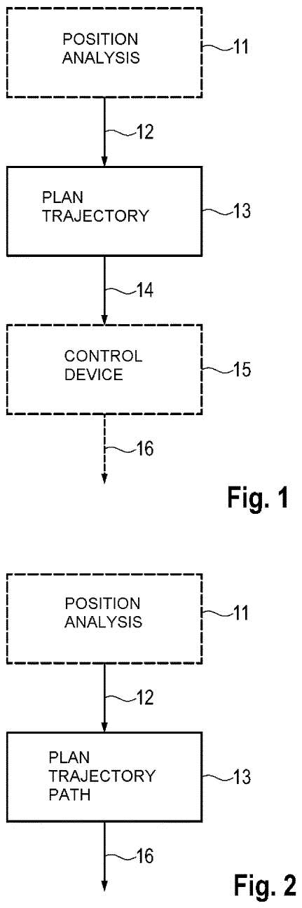

FIG. 1 illustrates the proposed architecture based on an interface that is compatible with the cascaded software architecture for autonomous vehicles. In this case, longitudinal acceleration and curvature on the trajectory planned locally according to the method 13 are fed as control commands 14 to a control device 15 that converts the control commands 14 into pedal and steering movements 16 of the vehicle.

The model-based framework shown in FIG. 2 makes it possible to extend this system to include models of the engine, powertrain and steering column dynamics to control the pedal and steering movements 16 directly based on the trajectory, for example using model-based prediction (model predictive control, MPC).

In both embodiments, the input 12 to the method 13 determined in the context of a position analysis 11 includes a driving path or path—for example in the form of the center and edges of the driving lane or desired geo-coordinates—the vehicle status, for example in the form of position, driving direction and speed, as well as relevant secondary conditions for the driving behavior, for example, regarding the tire grip, the maximum speed, and the position and speed of other moving objects and obstacles. The position and/or speed of other objects may be provided from at least one data source selected from an environment model, traffic information, swarm data and/or a vehicle-based camera system or radar systems such as LIDAR.

The control device 15 may comprise a computing unit for carrying out at least certain of the steps of the above-described method. A computing unit or a computer-assisted device comprises one or more processors, for example an all-purpose processor (CPU) or a microprocessor, RISC processor, GPU and/or DSP. By way of example, the computer-assisted device comprises additional elements such as storage device interfaces. Optionally or in addition, the terms denote a device that is able to execute a provided or incorporated program, preferably using a standardized programming language such as C++, JavaScript or Python, for example, and/or to control and/or access data storage apparatuses and/or other apparatuses such as input interfaces and output interfaces. The term computer-assisted device also refers to a multiplicity of processors or a multiplicity of (sub-) computers that are interconnected and/or otherwise communicatively connected and which possibly use one or more other resources, for example a storage device, together.

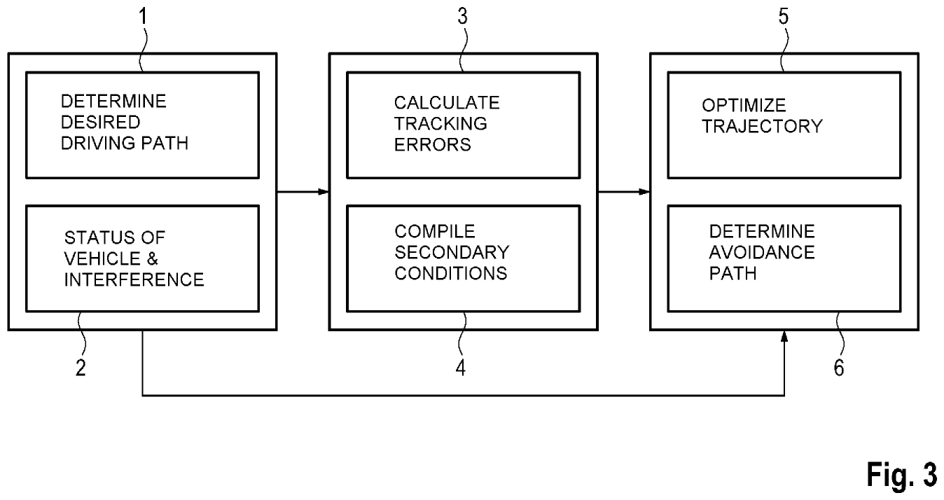

The process sequence of the method 13, controlled, for example, by software on board the vehicle, will now explained in detail based on FIG. 3.

In a first step (1), a driving path memory stores the last determined desired driving path of the vehicle at an overall planning level and delivers a preview for a narrow time window on a regular basis. Possible approaches include, for example, search-based or sample-based planning that can take place at a lower speed. The driving path memory or (data) storage device is for example a hard disk drive (HDD, SSD, HHD) or a (non-volatile) solid-state storage device, for example a ROM storage device or a flash storage device (flash EEPROM) The storage device often comprises a plurality of individual physical units or is distributed over a multiplicity of separate apparatuses such that access to said device is implemented by way of data communication, for example a package data service. The latter is a decentralized solution where storage devices and processors of a multiplicity of separate computing units are used instead of a (single unit) central on-board computer or in addition to a central on-board computer.

In a second step (2), the status of the vehicle and interference factors acting on the vehicle are estimated as part of a status monitoring process. Interference factors acting on the vehicle may be provided from at least one data source selected from an environment model, traffic information, swarm data, ego-sensor data, transverse offset, and planned trajectory/actual trajectory. Swarm data originates, for example, from other vehicles that have driven sections of the same route or formed similar trajectories. Such trajectories are valuable when combined with an evaluation, i.e. frequency, reason (e.g. evasive maneuver), etc. Interference factors also can be provided, for example, by a vehicle-based camera system or radar systems such as LIDAR.

In a third step (3), the current tracking errors are calculated on the basis of the driving path and the interfering factors (2), for example, in the form of course and position deviations along the driving path and transverse to the driving path.

In a fourth step (4), secondary conditions to be observed are compiled on the basis of the driving path and the interference factors (2) and are assigned to each time period of the time window considered in the first step (1). It is necessary to consider both static conditions imposed externally, such as the course of the road ahead according to a map, or the current weather, as well as dynamic conditions determined by other on-board software modules, such as the composition of the road surface or the location of obstacles and moving objects.

In a fifth step (5), the trajectory is optimized iteratively starting from the stored driving path in such a way that the tracking errors (3) are reduced and interference factors (2) are contained, but without violating the secondary conditions (4).

In a sixth step (6), an avoidance path (6) is determined on the basis of the first to fourth steps (1-4) according to an explicit calculation rule without real-time optimization, in order to provide an alternative in case the optimization algorithm (5) fails.

Finally, in the case of a step-by-step architecture, the trajectory or avoidance path (6) thus determined is fed to the dynamic vehicle controller (15—FIG. 1) on a subordinate level or, in the case of a monolithic architecture, directly to a model-predictive control system for the pedal and steering movements (16—FIG. 2).

This disclosure also relates to a computer program product having a computer-readable medium on which a program code executable on at least one computer unit of a vehicle is stored. The program code, when executed on the at least one computer unit, causes the at least one computer unit to perform at least one of the following steps in continuous iterative execution.

1. A method (13) for trajectory planning for a vehicle, comprising:
storing a desired driving path (1) of the vehicle;
observing external interference factors (2) on the vehicle;
calculating tracking errors (3) and secondary conditions (4) on the basis of the driving path (1) and the interference factors (2); and
optimizing a trajectory (5) in such a way that the tracking errors (3) are reduced within the secondary conditions (4).

2. The method (13) of claim 1, wherein: if optimizing (5) the trajectory fails, the method includes determining an avoidance path (6) that partially satisfies the secondary conditions (4).

3. The method (13) of claim 2, wherein the optimizing (5) is carried out starting from the stored driving path (1) in such a way that the interference factors (2) are contained.

4. The method (13) of claim 1, wherein the step of observing external interference factors (2) on the vehicle further includes observing a status of the vehicle and further basing the calculation (3, 4, 5) on the status.

5. The method (13) of claim 1, further comprising:
determining the driving path (1) by a position evaluation (11); and
controlling pedal and steering movements (16) of the vehicle so that the vehicle follows the trajectory.

6. The method (13) of claim 5, further comprising:
feeding longitudinal acceleration and curvature on the trajectory to a control device (15) as control commands (14); and
using the control device to convert the control commands the into pedal and steering movements (16).

7. The method (13) of claim 5, further comprising directly controlling the pedal and steering movements (16) by using the trajectory based on a model or model prediction.

8. A device for carrying out the method (13) of claim 1, comprising:
a driving path memory for storing the driving path (1),
means for monitoring at least the interference factors (2),
means for calculating the tracking errors (3),
means for calculating the secondary conditions (4) and
means for optimizing (5) the trajectory.

9. A computer program that is configured to carry out all steps of the method (13) of claim 5.

10. A machine-readable storage medium having the computer program of claim 9 stored therein.
